(19) United States
(12) Patent Application Publication
(10) Pub. No.: US 2016/0100244 A1
(43) Pub. Date: Apr. 7, 2016

(54) DEVICES AND TECHNIQUES RELATING TO TOUCH SENSITIVE CONTROL DEVICE

(71) Applicant: T+Ink, Inc., New York, NY (US)

(72) Inventors: John Gentile, Montclair, NJ (US); Anthony Gentile, New York, NY (US); Terrance Z. Kaiserman, Loxahatchee, FL (US); Steven Martin Cohen, New York, NY (US)

(73) Assignee: T+Ink, Inc., New York, NY (US)

(21) Appl. No.: 14/714,201

(22) Filed: May 15, 2015

Related U.S. Application Data
(60) Provisional application No. 61/994,503, filed on May 16, 2014.

(51) Int. Cl. H04R 1/10; G06F 3/041; G06F 3/044

(52) U.S. Cl. CPC H04R 1/1041; G06F 3/044; G06F 3/0414; H04R 2430/01

(57) ABSTRACT

Devices and techniques relating a touch-sensitive control device. An earphone apparatus is provided. The earphone apparatus comprises one or more speakers configured to convert audio signals to sound; one or more sensors; and a control unit coupled to the one or more sensors and configured to control an operation of a device based, at least in part, on signals provided by the one or more sensors.

### RELATED APPLICATIONS

This application claims priority to U.S. Provisional Application No. 61/994,503, filed May 16, 2014, which is incorporated herein by reference in its entirety.

### BACKGROUND

1. Field

The present disclosure relates generally to control devices. Some embodiments relate more particularly to touch sensitive and/or proximity sensitive control devices.

2. Related Art

Rheostats have been used to generate variable voltage since the harnessing of electricity in the nineteenth century. Wire wound resistors with wipers tapping intermediate points were supplemented with variably tapped resistive films and depositions. Volume controls became ubiquitous with the first vacuum tube radios and amplifiers, and have followed into the era of solid state and miniaturization. With analog and digital circuitry it became possible with buttons to ramp up or down more cost effectively what were formerly analog and variable parameters, though for some this came at the expense of the mechanical feel of a rheostat or linear fader providing precise variable control. Capacitive controls have become more popular, with application to elevator buttons, lighting and automotive controls, and touch screens.

### SUMMARY

According to an aspect of the present disclosure, an apparatus is provided, comprising: one or more wires at least partially enclosed in a wire cover; a sensor disposed on the wire cover, wherein a value of a property of the sensor is configured to change in response to application of force to the sensor; and a control unit coupled to the sensor and configured to control an operation of a device based, at least in part, on the change in the value of the property of the sensor.

In one aspect, an earphone apparatus is provided. The earphone apparatus comprises one or more speakers configured to convert audio signals to sound; one or more sensors; and a control unit coupled to the one or more sensors and configured to control an operation of a device based, at least in part, on second signals provided by the one or more sensors.

In one aspect, an earphone apparatus is provided. The earphone apparatus comprises one or more speakers configured to convert audio signals to sound, wherein the one or more speakers include a first speaker; a speaker housing configured to house the first speaker; and an information structure disposed on and/or in the speaker housing. The information structure comprising at least one first region and at least one second region, wherein at least one difference between the at least one first region and the at least one second region is detectable by a capacitive reader.

In one aspect, an earphone apparatus is provided. The earphone apparatus comprises one or more speakers configured to convert audio signals to sound. The one or more speakers include first and second speakers. The earphone apparatus further comprises first and second speaker housings configured to house the first and second speakers, respectively. The earphone apparatus further comprises a member coupling the first speaker housing to the second speaker housing and configured to partially cover a head of a user; and an information structure disposed on and/or in the member. The information structure comprises at least one first region and at least one second region, wherein at least one difference between the at least one first region and the at least one second region is detectable by a capacitive reader.

In one aspect, an apparatus is provided. The apparatus comprises one or more wires at least partially enclosed in a wire cover and a sensor disposed on the wire cover. A property of the sensor is configured to change in response to application of force to the sensor. The apparatus further comprises a control unit coupled to the sensor and configured to control an operation of a device based, at least in part, on the change in the property of the sensor.

In one aspect, a touch sensitive control device is provided. The device comprises a substrate; at least one activation area; a protective layer and/or coating; at least one conductive trace electrically connected to said at least one activation area; circuitry capable of producing measurable change of at least one parameter as a function of capacitance change of said at least one activation area; and a communication unit configured to communicate said measurable change to another device; a source of power; and a controller.

In one aspect, a touch sensitive control device is provided. The device comprises a substrate; at least one activation area; a protective layer and/or coating; at least one conductive trace electrically connected to said at least one activation area; circuitry capable of producing measurable change of at least one parameter as a function of capacitance change of said at least one activation area; and, a connecting unit configured to connect said at least one conductive trace to another device.

In one aspect, a touch sensitive control device is provided. The device comprises a substrate; at least one activation area; at least one conductive trace electrically connected to said at least one activation area; circuitry capable of producing measurable change of at least one parameter as a function of capacitance change of said at least one activation area; and a connecting unit configured to connect said at least one conductive trace to another device.

### BRIEF DESCRIPTION OF DRAWINGS

Various embodiments will be described with respect to the following Figures. It should be appreciated that the Figures are not necessarily drawn to scale. In the drawings, each identical or nearly identical component that is illustrated in various figures is represented by a like numeral. For purposes of clarity, not every component may be labeled in every drawing. In the drawings:

FIG. 1 shows an arrangement of activation areas (e.g., touch points), according to some embodiments;

FIG. 2A shows an arrangement of activation areas (e.g., touch points) coupled to conductive traces which are organized in a matrix, according to some embodiments;

FIG. 2B shows a schematic of the activation areas (e.g., touch points) and conductive traces of FIG. 2A, according to some embodiments;

FIG. 3 shows an arrangement of activation areas (e.g., touch points), according to some embodiments;

FIG. 4 shows a portion of an arrangement of activation areas (e.g., touch points) disposed (e.g., printed) upon the insulation of a two pair conductor cable (e.g., a pair of conductor cables attached to ear buds), according to some embodiments;

FIG. 5 shows a pair of triangular conductors, according to some embodiments;

FIG. 6 shows a pair of conductors with triangular spacing between them, according to some embodiments;.

FIG. 7 shows a pair of triangular conductors with triangular spacing between them, according to some embodiments;.

FIG. 8 shows a pair of conductors with triangular spacing between them and with calibration points at the beginning and end of the conductors, according to some embodiments.

FIG. 9A shows a pair of parallel conductors made from resistive materials, according to some embodiments;

FIG. 9B shows a conductor made from a resistive material and a conductor made from a low resistive material in a parallel arrangement, according to some embodiments;

FIG. 10 shows a schematic representation of the system depicted in FIG. 9A when a finger capacitively bridges between the two conductors, according to some embodiments;

FIG. 11 shows a schematic representation of the system depicted in FIG. 9B when a finger capacitively bridges between the two conductors, according to some embodiments;

FIG. 12 shows a finger sliding along a wire upon which an arrangement of activation areas (e.g., touch points) is disposed (e.g., printed), according to some embodiments;

FIG. 13 shows a representation of the entry of a slide code where the finger is not lifted from the wire and there are no discontinuities in the entry of the slide code, according to some embodiments;

FIG. 14 shows a representation of the entry of a slide code where the finger is lifted from the wire and there are discontinuities in the entry of the slide code, according to some embodiments;

FIG. 15 shows a representation of the entry of a combination of tap codes and slide codes, according to some embodiments;

FIG. 16 shows a substrate applied to a wire, according to some embodiments;

FIG. 17 shows a wire upon which a piezo material (e.g., piezoelectric and/or piezoresistive material) is disposed (e.g., printed and/or coated) to generate a voltage as the wire is being flexed, according to some embodiments;

FIG. 18 shows a wire in an overhand knot corresponding to a code entry, according to some embodiments; and

FIG. 19 shows two wires in an overhand knot and a bight configuration corresponding to a code entry, according to some embodiments.

FIG. 20 shows a force applied to one cup of a pair of headphones, according to some embodiments.

FIG. 21A show a person wearing a pair of headphones, according to some embodiments, and FIG. 21B shows a pair of headphones being removed from one side of a person, according to some embodiments.

FIG. 22 shows a touch code applied to one side of a pair of headphones, according to some embodiments.

### DETAILED DESCRIPTION

As used herein, a “slide code” may include, but is not limited to, a code entered into an arrangement of one or more activation areas (e.g., a linear array of activation areas) using a sliding motion (e.g., via touch, though embodiments are not limited to entry of slide codes via touch). In some embodiments, a slide code may be entered by sliding a finger along a wire for some distance, changing direction and sliding in the opposite direction, then terminating motion or changing direction and continuing. In some embodiments, entering a slide code may include sliding a finger along a wire for some distance, raising the finger, skipping over a section of the wire, touching the wire in another place, and continuing to slide either in the same direction or in the opposite direction. Any number of starting and terminating positions are possible, as are any number of direction changes and/or lifting of the finger and continuing motion at another location on the wire.

As used herein, a “smart device” may include, but is not limited to, any device having a capacitive touch screen, including but not limited to an I-pad, I-phone, Android device, tablet, any device commonly referred to as a smart phone, a touch screen in a car, a GPS unit, a touch sensitive screen on slot machine and/or a custom capacitive and/or touch sensitive screen.

As used herein, a “tap code” may include, but is not limited to, a code entered into an arrangement of one or more activation areas (e.g., a linear array of activation areas) using a tapping motion. In some embodiments, a tap code may be entered by touching (though not limited to touch) at one or more locations in the arrangement of one or more activation areas (e.g., along the length of a linear array of activation areas), such as touching one or two or more times at one location followed by touching at least one time at another location in the arrangement (e.g., along the linear array).

As used herein, a “touch code” may include an information structure comprising at least one first region and at least one second region, wherein at least one difference between the at least one first region and the at least one second region is detectable by a capacitive reader. In some embodiments, a touch code may include a conductive area of a particular shape and/or pattern that may be decoded (e.g., uniquely decoded) to produce one of many possible states. In some embodiments, the touch code may include at least one of a series of bars of varying sizes, circles of various sizes and/or angular relationships to one another, rectangular shapes, and/or any geometric shape or shapes that can be quantified and decoded into one of a multiplicity of states. In some embodiments, the conductive areas may include, but are not limited to, printed conductive inks.

As used herein, a “sensor” may include, but is not limited to, a device, structure, or material configured to undergo a change in the value of one or more properties in response to a force applied to the sensor. In some embodiments, a sensor may comprise one or more activation areas (e.g., electrodes, touch points, touch point electrodes).

As used herein, a “wire cover” may include, but is not limited to, a material which at least partially covers or encloses at least a portion of one or more wires. In some embodiments, the wire cover may insulate (e.g., thermally insulate, electrically insulate, optically insulate, etc.) at least a portion of a wire. In some embodiments, the wire cover may provide structural support and/or protection for the wire. Some embodiments of a wire cover may include any suitable material(s), including, but not limited to, one or more plastics (e.g., polyvinyl chloride (PVC), semi-rigid PVC, plenum PVC, polyethylene (PE), polypropylene (PP), polyurethane (PUR), chlorinated polyethylene (CPE), or nylon), one or more rubbers (thermoplastic rubber (TPR), polychloroprene (neoprene), styrene butadiene rubber (SBR), silicone, fiberglass, ethylene propylene rubber (EPR), rubber, chlorosulfonated polyethylene (CSPE), or ethylene propylene diene monomer (EPDM)), and/or one or more polymers (e.g., fluoropolymers, PFA, polytetrafluoroethylene (PTFE), fluorinated ethylene propylene (FEP), ETFE Tefzel, ECTFE Halar, polyvinylidene fluoride (PVDF), or thermoplastic elastomers (TPE)).

According to an aspect of the present disclosure, a device may combine capacitive, resistive, and/or piezoelectric controls with a linear fader to make possible the sliding of a finger or fingers along a wire and/or surface to set a level of a parameter.

According to an aspect of the present disclosure, a control device (e.g., a linear control device) may be applied to a surface and/or a wire, with the ability to change a parameter, such as music volume, in response to an object (e.g., finger) sliding across the surface and/or wire, such as an earphone wire. In some embodiments, capacitive and/or resistive coupling may be used to detect the object and/or to determine the value of the parameter based on the object. Some embodiments are not limited by the type of wire upon which the control device is applied. Some embodiments are not limited by the type(s) of parameter(s) controlled by the control device.

According to an aspect of the present disclosure, there is provided a touch sensitive control device (e.g., linear control device) comprising: a substrate, at least one activation area (e.g., conductive activation area), a protective layer and/or coating, at least one conductive trace electrically connected to at least one activation area, circuitry capable of producing a measurable change of at least one parameter as a function of capacitive and/or resistive change of at least one activation area, a communication unit configured to communicate measurable change to another device, a source of power, and/or a controller.

In some embodiments, at least one activation area may be discrete. In some embodiments, at least one activation area may be formed on or attached to a substrate via printing, etching, deposition, in-molding, adhesive application, molding, shrink wrapping, bonding, lamination (hot and/or cold), and/or coating.

In some embodiments, the substrate may comprise a first substrate comprising the insulation of a wire, a second substrate applied to the first substrate, rigid or flexible plastic, at least one part of a plastic housing, and/or other material. In some embodiments, the first substrate and/or second substrate may be accessible to be touched by at least one finger. In some embodiments, the first substrate and/or second substrate may be flexible, thereby allowing the wire to bend.

In some embodiments, the source of power may be provided by another device and/or used to provide power to another device. In some embodiments, the source of power may include at least one battery(e.g., at least one battery used for powering at least one other component, at least one system, or at least one subsystem), at least one audio signal, at least one capacitor, at least one solar cell, and/or at least one piezoelectric material.

In some embodiments, the circuitry capable of producing measurable change of at least one parameter as a function of capacitance and/or resistive change of at least one activation area (e.g., conductive activation area) may be located in or part of another device. In some embodiments, the controller may be located in or part of another device.

In some embodiments, the wire and/or second substrate may be at least one part of, may be applied to, and/or may be used for headphones, ear buds, a charging cord, antenna, wire for supplying power, litz wire, multi-conductor cable, Cat5 and/or Cat6 and/or Cat5e cable, coax cable, shielded cable, non-shielded cable, ribbon cable, cable of any kind wherein conductive elements are contained within an insulating and/or shielding material, fiber optic cable, flexible materials (including but not limited to ropes, strings, chords, thongs, hides, cloth, synthetic materials, non-synthetic materials), rubber, plastic, woven materials, extruded materials, cast materials, non-flexible materials (including but not limited to rods, poles, plates, structural elements, plastic, insulated and/or non-insulated metal), wood, masonry, building materials, composites, castings, weldments, and/or molded materials.

In some embodiments, the at least one parameter in which the measurable change is produced may comprise frequency, resistance, voltage, capacitance, inductance, coupling, circuit Q (e.g., quality of resonance factor), quantifiable electromagnetic field distortion, and/or electrostatic field distortion.

In some embodiments, the at least one activation area may comprise a plurality of activation areas capable of producing a plurality of states. The plurality of states may correspond to a plurality of values of at least one level and/or at least one variable. The level and/or variable may include, but is not limited to volume, turning down volume, turning up volume, setting or restoring volume to a preset level, pausing at least one sound, starting at least one sound, restarting at least one sound, advancing to another song, changing balance (e.g., left-right balance), frequency, parameters necessary or useful for playing music (e.g., base, treble, midrange, cutoff frequency, graphic equalization, reverb, echo, channel selection, and/or song selection), color selection, lighting control of at least one lighting parameter, lighting control of at least one color parameter, environmental control (including but not limited to temperature, humidity, airflow), position control of parameters displayed on other graphic display systems on other devices, at least one parameter anything can be functionally dependent upon, robotic control, at least one code in whole or in part used for access to information systems, databases, processing capability, and/or communication, machinery unlocking, machinery locking, machinery access, product selection, product purchasing, order modification, and/or use with and/or to supplement other data entry devices and/or systems.

In some embodiments, the touch sensitive control device (e.g., linear control device) may comprise two or more touch sensitive control devices on one controller at one location. For instance, one touch sensitive control device may control one variable such as loudness while another touch sensitive control device may control another variable such as balance or channel. In some embodiments, one touch sensitive control device at one location may control variables at more than one location, thus transforming the device into a universal rheostat (e.g., a resistive and/or capacitive rheostat); in other words, one touch sensitive control device may control one thing at one location and may also control another thing at another location. In some embodiments, one touch sensitive control device at multiple locations may control variables at one location. For example, in a scenario whereby two people A and B are each listening to their respective music, A may lower the volume on B's listening device so B can hear what A has to say. B or A may then restore B's volume to its previous setting. In some embodiments, at least one touch sensitive control device in at least one location may be a master controller and at least one touch sensitive control device in at least one other location may be a slave controller, and the master controller may have priority (e.g., via a hierarchy of rules) over the slave controller. In this scenario, a mother and/or father may lower the volume of the music of one or more child but one or more child may not unless authorized lower the volume of the mother's and/or father's music, and this relationship may be defined via a hierarchy of rules.

In some embodiments, the touch sensitive control device may be used to enter at least one of a security code and/or control code. The at least one security code and/or control code may comprise at least one movement from at least one activation area to another at least one activation area in a continuous motion; and/or at least one movement from at least one activation area to another at least one activation area in a continuous motion followed by at least one other at least one movement from at least one activation area to another at least one activation area in a continuous motion; and/or either no tapping or at least one tapping out of at least one touch followed by at least one movement from at least one activation area to another at least one activation area in a continuous motion followed by either no tapping or at least one tapping out of at least one touch; and/or at least one of either no tapping or at least one tapping out of at least one touch followed by at least one movement from at least one activation area to another at least one activation area in a continuous motion followed by either no tapping or at least one tapping out of at least one touch.

A code entered by at least one movement from at least one activation area to another at least one activation area in a continuous motion may be referred to as a slide code. A code entered by tapping one or more activation areas one or more times may be referred to as a tap code. A code entered either by touching (but not tapping) an activation area, or by tapping one or more activation areas one or more times may be referred to as a tactile code. The time between at least one tapping and another at least one tapping may be variable and part of at least one security code and/or control code, and/or the time for at least one movement from at least one activation area to another at least one activation area in a continuous motion may be variable and part of at least one security code and/or control code, and/or the time between at least one tapping (e.g., the initiation or termination of at least one tapping) and the beginning of at least one movement may be variable and part of at least one security code and/or control code. Thus, in some embodiments a security code and/or control code may comprise one or more slide codes and/or one or more tap codes and/or the timing of and between the one or more slide codes and/or tap codes, and in this manner many separate and unique security codes exist and may be generated. In some embodiments, the variable, security code, and/or control code may comprise an error corrected variable, security code, and/or control code based on a range of acceptable time(s), tapping(s), and/or movement(s).

In some embodiments, at least one activation area may comprise at least one single common activation area in close proximity to a plurality of activation areas. In some embodiments, at least activation area may comprise a plurality of conductive traces configured as at least one matrix. In some embodiments, the matrix may be configured to cover at least one area. In some embodiments, the at least one matrix may comprise a first matrix with a first arrangement of cross points between a first set of activation areas and the conductive traces, and a second matrix with a second arrangement of cross points between a second set of activation areas and the conductive traces, such that each pair of adjacent cross points defines a unique location along the control device.

In some embodiments, at least one activation area may comprise a pair of activation areas formed by non-parallel conductive lines. In some embodiments, the non-parallel conductive lines may be made from low resistive material and/or high resistive material. In some embodiments, the coupling may be caused to occur between at least one activation area and another at least one activation area by the action of an object (e.g., a finger), and the coupling location within an activation area (e.g., the location across the length of a high resistive material) may alter the electrical properties of an electronic circuit such that a variable parameter may be measured and quantified to produce a range of values that may be translated into data and/or signals for control of at least one thing functionally dependent upon the data and/or signals.

In some embodiments, the touch sensitive control device further comprises at least one other activation area configured to serve as at least one position calibration location, at least one input, and/or at least one control.

In some embodiments, the touch sensitive control device further comprises one or more piezoelectric coatings configured to act as a device, including, but not limited, to a flex sensor, force sensor, bend sensor, stretch sensor, microphone, speaker, and/or transducer.

In some embodiments, at least one conductive trace electrically connected to at least one activation area may comprise a first conductive trace electrically connected to a first activation area, the first conductive trace and/or first activation area being three dimensionally stacked and/or layered on top of a second conductive trace electrically connected to a second activation area.

In some embodiments, the communication unit may be configured to communicate measurable change to another device using communication via a wireless communication method and/or communication via a conductive element connected to that other device.

In some embodiments, the touch sensitive control device may further comprise a light generation unit configured to generate at least one light.

In some embodiments, the touch sensitive control device may further comprise activation areas (e.g., touch points) that employ resistive connection between at least two conductive elements and/or employ resistive connection to cause closure of at least one switch. In some embodiments, the resistive connection may include, but is not limited to, skin and/or human touch and/or at least one other at least two conductive elements.

In some embodiments, the circuitry capable of producing measurable change of at least one parameter as a function of capacitive and/or resistive change of at least one activation area may be capable of sensing change of the at least one parameter over a range of distances between an object (e.g., finger, hand, or stylus) and the at least one activation area and/or positions of the object relative to the at least one activation area. In some embodiments, the circuitry may produce at least one variable value representing at least one radius from at least one activation area to an object (e.g., finger, hand, or stylus). In some embodiments, at least one variable value representing at least one radius from at least one capacitive plate to an object may comprise a multiplicity of values in at least one array. In some embodiments, the at least one activation area or capacitive plate may include, but is not limited to, any electrically isolated metal surface such as at least one plate, rod, weldment, fabrication, subassembly, assembly, doorknob, door, lighting switch plate, lamp, shelf, desk, filing cabinet, appliance (e.g., kitchen and/or home/and or workplace and/or shop appliance), tool, electronic equipment, stool, and/or furniture.

In some embodiments, the touch sensitive control device may be controlled by at least one controller in at least one location. In some embodiments, a first touch sensitive control device controlled by at least one controller in at least one location may be a master controller and a second touch sensitive control device controlled by at least one controller in at least one other location may be a slave controller, and the master controller may have priority via a hierarchy of rules over the slave controller.

In some embodiments, at least one battery (e.g., at least one battery used for powering at least one other component or components or at least one system or at least one subsystem) may be rechargeable from at least one other source of power including but not limited to at least one other battery, USB port, wall adapter, wireless inductive means, solar cell and/or piezoelectric material.

In some embodiments, at least one conductive activation area may be arranged, in whole or in part, in a circular, curved, and/or linear pattern.

According to an aspect of the present disclosure, a touch sensitive control device may be provided, comprising a substrate, at least one activation area, a protective layer and/or coating, at least one conductive trace electrically connected to at least one activation area, circuitry capable of producing measurable change of at least one parameter as a function of capacitive and/or resistive change of at least one activation area, and a connection unit configured to connect said at least one conductive trace to another device. In some embodiments, at least one activation area may be capacitive and/or resistive. In some embodiments, the activation area may comprise a capacitive plate. In some embodiments, at least one activation area may include, but is not limited to, any electrically isolated metal surface such as at least one plate, rod, weldment, fabrication, subassembly, assembly, doorknob, door, lighting switch plate, shelf, desk, filing cabinet, appliance (e.g., kitchen and/or home/and or workplace and/or shop appliance), tool, electronic equipment, and/or stool.

According to an aspect of the present disclosure, a touch sensitive control device may be provided, comprising a substrate, at least one activation area, at least one conductive trace electrically connected to at least one activation area, circuitry capable of producing measurable change of at least one parameter as a function of capacitive and/or resistive change of at least one activation area, and a connection unit configured to connect at least one conductive trace to another device. In some embodiments, at least one activation area may be capacitive and/or resistive. In some embodiments, the activation area may comprise a capacitive plate. In some embodiments, at least one activation area may include, but is not limited to, any electrically isolated metal surface such as at least one plate, rod, weldment, fabrication, subassembly, assembly, doorknob, door, lighting switch plate, shelf, desk, filing cabinet, appliance (e.g., kitchen and/or home/and or workplace and/or shop appliance), tool, electronic equipment, and/or stool.

In some embodiments, the substrate of a touch sensitive control device may be part of a cable and/or wire (e.g., in headphones, including, but not limited to, ear buds) or incorporated within a subassembly in series with a cable and/or wire (e.g., in headphones, including, but not limited to, ear buds. In some embodiments, the control device may communicate a measurable change of at least one parameter to another device by producing at least one sequence of pulses (e.g., a sequence of pulses that emulate the pressing of at least one button in series with an impedance (e.g., a complex impedance)). In some embodiments, the subassembly and/or sequence of pulses may be compatible with conventional volume control systems and/or methods of manufacturing conventional volume control signals. The at least one sequence of pulses may emulate one button pressing, two button pressings, three button pressings, four button pressings, five button pressings, six button pressings, seven button pressings, eight button pressings, nine button pressings, ten button pressings, eleven button pressings, twelve button pressings, thirteen button pressings, fourteen button pressings, fifteen button pressings, sixteen button pressings, and/or more than sixteen button pressings. In some embodiments, the source of power may comprise at least one battery (e.g., at least one battery used for powering at least one other component or components or at least one system or at least one subsystem), at least one audio signal, at least one capacitor, at least one solar cell, and/or at least one piezoelectric material. In some embodiments, the at least one battery may be rechargeable from at least one other source of power including but not limited to at least one other battery, USB port, wall adapter, wireless inductive power source, at least one solar cell, and/or at least one piezoelectric material.

According to an aspect of the present disclosure, an earphone device may be provided. In some embodiments, an earphone device may comprise any device suitable for producing sound in proximity to one or more of a user's ears, including, but not limited to, one or more earphones (e.g., “ear buds,” “ear cups,” or “headphones”) (e.g., two earphones, sometimes referred to as a “pair of earphones”). In some embodiments, the earphone device may be head-mounted and/or ear-mounted (e.g., one or more of the earphones may be head-mounted and/or ear-mounted). In some embodiments, an earphone may comprise a speaker housing and one or more speakers housed in the speaker housing.

In some embodiments, the earphone device may further comprise at least one activation area (e.g., conductive activation area) located on an earphone (e.g., a left activation area located on a left earphone speaker housing), at least one activation area located on another earphone, at least one activation area located on a member (e.g., flexible connecting member) that connects the two earphones (e.g., left earphone and the right earphone), piezoelectric material, flex sensor, force sensor, bend sensor, stretch sensor, microphone, speaker, and/or transducer.

In some embodiments, the earphone device may generate a first control parameter as a result of touching one or more of the activation areas (e.g., at least one left activation area, at least one right activation area, at least one left activation area and at least one right activation area, at least one central activation area, at least one central activation area and at least one left activation area, at least one central activation area and at least one right activation area), spreading one or more of the earphones (e.g., spreading the right earphone relative to the left earphone, spreading the left earphone relative to the right earphone, spreading the left earphone relative to the right earphone and the right earphone relative to the left earphone simultaneously), and/or compressing one or more of the earphones (e.g., compressing inward the left earphone and/or compressing inward the right earphone).

In some embodiments, at least one activation area may be arranged, in whole or in part, in a circular, curved, and/or a linear pattern.

In some embodiments, an earphone may comprise an ear cup (e.g., the right earphone may comprise a right ear cup, and/or the left earphone may comprise a left ear cup). In some embodiments, one or more earphones may comprise conductive material (e.g., conductive fiber fill, conductive foam, and/or a conductive coating) having a resistance configured to change in response to application of force to the conductive material (e.g., the right ear cup, left ear cup, right earphone housing, and/or left earphone housing may comprise, in whole or in part, conductive fiber fill, conductive foam, and/or a conductive coatings that changes resistance with pressure or movement or conductive outer materials that are in at least one location). The conductive fiber fill, conductive foam, and/or conductive coatings that change resistance with pressure or movement or conductive outer materials may, in some embodiments, produce a change of resistance as a function of compression or expansion. Compression may occur when at least a portion of an earphone (e.g., an ear cup) is pressed inward at least one time toward a head or surface possessing enough rigidity to enable the portion of the earphone to change shape. Expansion may occur when at least a portion of an earphone (e.g., an ear cup) is pulled outward at least one time away from a head or surface possessing enough rigidity to enable the portion of the earphone to change shape. In some embodiments, the conductive material may include any suitable material having a resistance changes in response to compression or expansion, including, but not limited to conductive foam, polyurethane foam, carbon-impregnated foam, anti-static foam, electro-static discharge foam, resistive foam, and/or conductive materials described in U.S. Pat. No. 5,855,818, which is hereby incorporated by reference herein in its entirety.

In some embodiments, at least one activation area can be waterproof. In some embodiments, at least one activation area may be used for gesture sensing based on capacitance of a hand or body part in spatial proximity of at least one activation area.

In some embodiments, the earphone device may be configured to cause at least one action to occur based on the ability to process at least one signal and at least one signature resulting from of at least one of sliding in at least one location, sliding in at least one location with at least one dwell for a period of time, tapping in at least one location, tapping in at least one location with at least one dwell for a period of time, at least one dwell for a period of time followed by tapping in at least one location followed by at least one dwell for a period of time, at least one dwell for a period of time followed by sliding in at least one location followed by at least one dwell for a period of time, and/or at least one of any suitable gesture.

In some embodiments, the change of resistance may include at least one change of resistance. In some embodiments, at least one change of resistance may include a second signature. The second signature may, in some embodiments, control at least one operation including but not limited to turning down volume, turning up volume, setting or restoring volume to a preset level, pausing at least one sound, starting at least one sound, restarting at least one sound, advancing to another song, changing a parameter (e.g., left-right balance, frequency, any parameters necessary or useful for playing music, base, treble, midrange, cutoff frequency, graphic equalization, reverb, and/or echo), channel selection, song selection, color selection, lighting control of at least one lighting parameter, lighting control of at least one color parameter, environmental control (including but not limited to control of temperature, humidity, and/or airflow), position control of parameters displayed on one or more graphic display systems (e.g., on other devices), changing at least one parameter anything is functionally dependent upon, robotic control, entry and/or verification of at least one code in whole or in part used for access (e.g., to information systems, data bases, and/or processing capability), communication, machinery unlocking, machinery locking, machinery access, product selection, product purchasing, order modification, and/or use with and/or to supplement other data entry devices and/or systems.

In some embodiments, the second signature may comprise at least one parameter change. In some embodiments, at least one parameter change may include, but is not limited to, at least one of the mathematical first, second, and/or third derivative of resistance, resistance change, capacitance, capacitance change, force, force change, pressure, pressure change, inductance, inductance change, position, position change, piezoelectric compression or expansion, voltage pulses, and/or spectral composition of a time varying signal.

According to another aspect of the present disclosure, at least one control panel may be formed from at least one activation area (e.g., conductive activation area). In some embodiments, at least one control panel may be configured to control at least one of communication with a smart device, turning down volume, turning up volume, setting or restoring volume to a preset level, pausing at least one sound, starting at least one sound, restarting at least one sound, advancing to another song,

Changing a parameter (e.g., left-right balance, frequency, any parameters necessary or useful for playing music, base, treble, midrange, cutoff frequency, graphic equalization, reverb, and/or echo), channel selection, song selection, color selection, lighting control of at least one lighting parameter, lighting control of at least one color parameter, environmental control (including but not limited to control of temperature, humidity, and/or airflow), position control of parameters displayed on one or more graphic display systems (e.g., on other devices), changing at least one parameter anything is functionally dependent upon, robotic control, entry and/or verification at least one code in whole or in part used for access (e.g., to information systems, data bases, and/or processing capability), communication, machinery unlocking, machinery locking, machinery access, product selection, product purchasing, order modification, and/or use with and/or to supplement other data entry devices and/or systems.

In some embodiments, a device may comprise at least one touch code. In some embodiments, at least one touch code may be read using a touch sensitive screen of a smart device. In some embodiments, at least one touch code may be used for at least one of authentication, counterfeit detection, and/or security code (e.g., security code used in conjunction with other information, and/or security code used in conjunction with other customer-specific information).

According to another aspect of the present disclosure, an earphone device may comprise at least one biometric-environmental sensor (e.g., a physiological sensor). In some embodiments, at least one biometric-environmental sensor may be configured to detect at least one of a human parameter and/or an environmental parameter. In some embodiments, at least one biometric-environmental sensor may comprise at least one of a humidity sensor, temperature sensor, pressure sensor, Doppler sensor, airflow sensor, force sensor, optical sensor (e.g., optical sensor with filter, optical sensor with polarizer, and/or optical sensor with filter and polarizer), at least one LED, angle sensor, gyroscope sensing rotation in at least one axis, and/or accelerometer that senses acceleration along at least one axis. In some embodiments, at least one LED may comprise at least one of IR LED, UV LED, and/or visible LED. In some embodiments, at least one human parameter may comprise at least one of heart rate, blood oxygenation level, blood deoxygenation level, temperature, respiration rate, blood pressure, blood flow, steps per unit of time, speed, and/or acceleration (e.g., magnitude of vertical acceleration).

In some embodiments, at least one human parameter may be combined with at least one other human parameter to produce at least one biometric signature. In some embodiments, at least one biometric signature may be used to perform at least one operation, including, but not limited to, altering at least one sound, signaling distress, calling 911, dialing a phone number, communicating with another device (e.g., a smart device), communicating with one or more websites, and/or engaging in a social community of others engaging in the same or different activities. In some embodiments, the altered sound may comprise at least one of type of music, music, rhythm, amplitude, frequency, frequency spectrum, pitch bending, modulation, side band, amplitude modulated sound, frequency modulated sound, amplitude and frequency modulated sound, white noise, pink noise, synthesized sound, artificially produced sound, naturally produced sound, recorded sound, recorded and altered sound, filtered sound, and/or at least one sound combined with at least one other sound. In some embodiments, the biometric-environmental sensor may perform the same function as a pulse oximeter using the ear or other skin.

FIG. 1 shows an arrangement of ten activation areas (e.g., ‘touch points,’ ‘electrodes,’ or ‘touch point electrodes’), according to some embodiments. In some embodiments, in response to an object (e.g., finger) sliding between the common trace 11 and electrodes E1-E10 (1-10), a parameter such as volume would be controlled between levels (e.g., minimum and maximum levels). In some embodiments, a signal might be injected across the common trace 11, be transmitted through the object disposed between the common trace 11 and an electrode, and be detected on a trace coupled to that electrode. In another embodiment there might not be a common trace 11 and only the ten single electrodes E1 through E10, though it is not limited to ten electrodes and ten electrodes are only shown as an example.

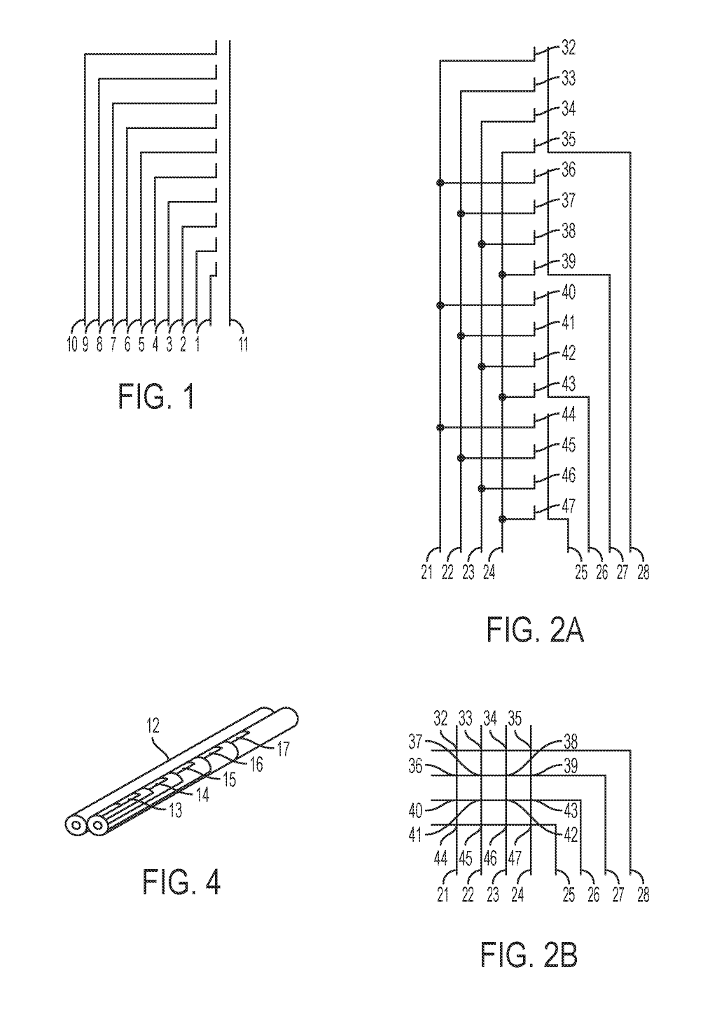

FIG. 2A shows an arrangement of activation areas (e.g., ‘touch points,’ ‘electrodes,’ or ‘touch point electrodes’) coupled to conductive traces which are organized in a matrix, according to some embodiments. In the example of FIGS. 2A and 2B, the activation areas are arranged in succession, and the conductive traces are organized in a 4×4 matrix. In this arrangement, four conductive traces (25-28) are arranged as rows, and four conductive traces (21-24) are arranged as columns. As can be seen in FIG. 2B, the four column traces and four row traces may be arranged to realize sixteen individual points of resolution. For instance, at the intersection of column line 21 and row line 28 is activation area 32. In some embodiments, signals may be transmitted one at a time on the rows (or columns), and activation of an activation area (32-47) at the intersection of a particular row and column may be detected when the signal transmitted on the particular row (or column) is detected on the particular column (or row). In this manner, row and column lines may be used to address the activation areas (32-47).

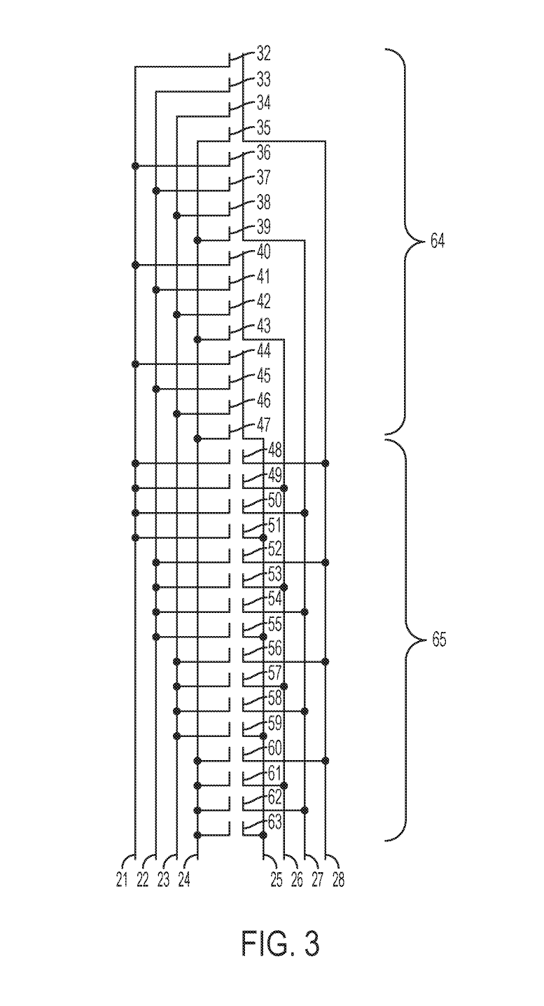

FIG. 3 shows an arrangement of activation areas (e.g., ‘touch points,’ ‘electrodes,’ or ‘touch point electrodes’), according to some embodiments. In the example of FIG. 3, four row lines and four column lines are used to address 32 activation areas (32-63). As can be seen, in upper matrix 64 of FIG. 3, the row and column lines are organized in the same manner shown in FIGS. 2A and 2B. By contrast, in lower matrix 65, the row and column lines are organized in a different manner. In the example of FIG. 3, each row-column pair addresses an activation area in the upper matrix and an activation area in the lower matrix. For instance, column line 21 and row line 28 address activation areas 32 and 48. Thus, in the example of FIG. 3, it may not be possible to uniquely determine which activation area is activated using only the current row and column signals. However, in some embodiments, it may be possible to determine which activation area is activated using the current row and column information and previous row and column information. For example, as an object (e.g., finger) slides from activation area 32 to adjacent activation area 33, the matrix scan signals may be detected first on row 28 and column 21 (for activation area 32), and then on row 28 and column 22 (for activation area 33). By contrast, as an object slides from activation area 48 to activation area 49, the matrix scan signals may be detected first on row 28 and column 21 (for activation area 48), and then on row 26 and column 21 (for activation area 49). In this manner, it is possible to address thirty-two or even more activation areas using only eight matrix lines.

FIG. 4 shows a portion of an arrangement of activation areas (e.g., ‘touch points,’ ‘electrodes,’ or ‘touch point electrodes’) disposed (e.g., printed) upon the insulation of a two pair conductor cable 12 as might be used on ear buds. Shown are activation areas 13-17.

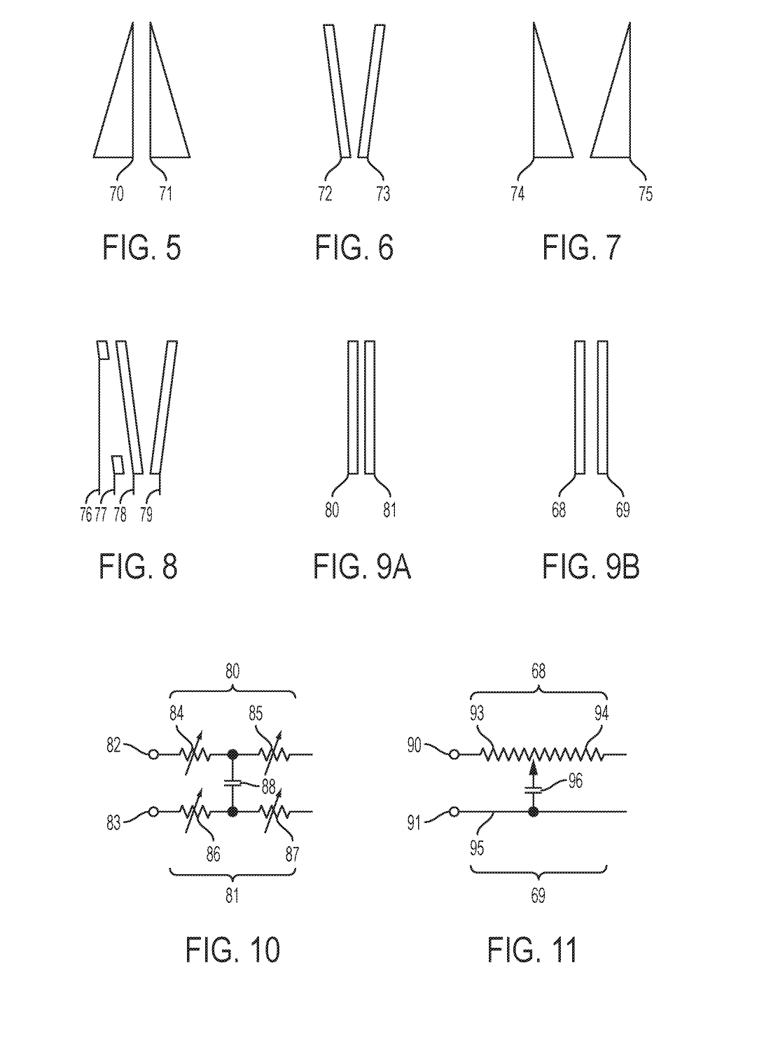

FIG. 5 shows a pair of triangular conductors, according to some embodiments. In some embodiments, the triangular conductors include left triangular electrode 70 and right triangular electrode 71. In some embodiments, the coupling (e.g., capacitive and/or resistive coupling) between the left and right electrodes may differ at different locations along the length of the two electrodes. For example, the coupling between the left and right triangular electrodes may be greater at locations where the left and right triangular electrodes are wider. The difference in coupling at different locations along the electrodes may be exploited to determine a location of an object (e.g., a finger) between the two electrodes. For example, the difference in coupling at different locations along the two electrodes may be exploited to produce a quantifiable parameter that is dependent on (e.g., proportional to) a finger position. In some embodiments, the left and right triangular electrodes may comprise highly conductive material (e.g., metallic material).

FIG. 6 shows a pair of conductors with triangular spacing between them, according to some embodiments. In the example of FIG. 6, left electrode 72 is separated from right electrode 73 by a distance which increases from the lower portions of the electrodes to the upper portions of the electrodes. In some embodiments, the coupling (e.g., capacitive and/or resistive coupling) between the left and right electrodes may differ at different locations along the length of the two electrodes. For example, the coupling between the left and right triangular electrodes may be greater at locations where the distance between the left and right triangular electrodes is smaller. The difference in coupling at different locations along the electrodes may be exploited to determine a location of an object (e.g., a finger) between the two electrodes. For example, the difference in coupling at different locations between the two electrodes may be exploited to produce a quantifiable parameter that is dependent on (e.g., proportional to) a finger position.

FIG. 7 shows a pair of triangular conductors comprising left triangular electrode 74 and right triangular electrode 75 with triangular spacing between them. In some embodiments, triangular electrodes with triangular spacing between them may combine the effects or triangular electrodes with uniform spacing between them (discussed above in connection with FIG. 5) and rectangular electrodes with triangular spacing between them (discussed above in connection with FIG. 6).

FIG. 8 shows a pair of conductors comprising left electrode 78 and right electrode 79 with triangular space between them as depicted in FIG. 6, with the addition of calibration points at the beginning bottom plate 77 and end top plate 76 of the conductors.

FIG. 9A and its electrical schematic representation in FIG. 10 show a pair of parallel conductors made from resistive materials (e.g., ceramic materials, organic materials, and/or glass materials). In the example of FIG. 9A, left resistive electrode 80 and right resistive electrode 81 form a pair of parallel tracks, and an object (e.g., finger) coupling between the two resistive electrodes changes the resistance between upper terminal 82 corresponding to electrode 80 and lower terminal 83 corresponding to electrode 81. Upper close resistive portion 84 and upper far resistive portion 85 form resistive electrode 80, and lower close resistive portion 86 and lower far resistive portion 87 form resistive electrode 81. As can be seen, the amount of resistance placed in series between upper terminal 82 and lower terminal 83 depends on the location of an object which forms a capacitive bridge 88 between the pair of electrodes.

FIG. 9B and its electrical schematic representation in FIG. 11 show a conductor made from a resistive material (left resistive electrode 68) and a conductor made from a low resistive material (right conductive electrode 69), the resistive material and the low resistive material being arranged in parallel. In FIG. 11, right conductive electrode 69 is depicted as conductive element 95. In FIG. 11, left resistive electrode 68 comprises near resistive portion 93 and far resistive portion 94. As can be seen, the amount of resistance placed in series between upper terminal 90 and lower terminal 91 depends on the location of an object which forms a capacitive bridge 96 between the pair of electrodes.

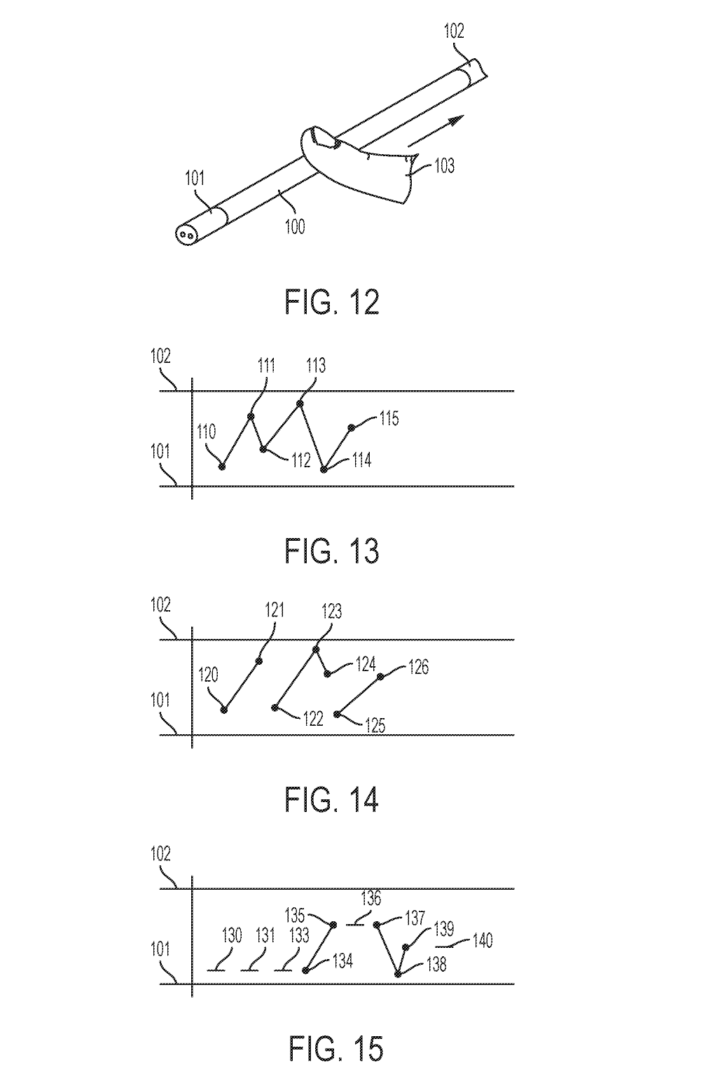

FIG. 12 shows a finger 103 sliding along a wire 100 upon which an arrangement of activation areas (e.g., ‘touch points,’ electrodes,' or ‘touch point electrodes’) is disposed (e.g., printed). The activation areas are located between the beginning 101 of a sensing region and the end 102 of the sensing region, and the finger 103 slides between these two regions.

FIGS. 13-15 illustrate motion of finger 103 along wire 100, with the horizontal axis representing time and the vertical axis representing position of finger 103 between the beginning 101 and end 102 of the sensing region. FIG. 13 shows a representation of the entry of a slide code where the finger 103 is not lifted from the wire and there are no discontinuities in the entry of the slide code. Depicted is the slide code being entered between the beginning of sensing region 101 and the end of sensing region 102. In the example of FIG. 13, the slide code begins with the finger sliding from slide code point 110 to slide code point 111, where it changes directions heading to slide code point 112, where again it changes direction headed toward slide code point 113, before changing direction again heading toward slide code point 114, and finally terminating at slide code point 115. In some embodiments, huge numbers of codes may be entered in this manner, and coupled with error correction where the exact starting and ending positions are not necessary, an algorithm may determine the intentions of the user by virtue of extending the starting and ending ranges acceptable for code entry.

FIG. 14 shows a representation of the entry of a slide code where the finger is lifted from the wire and there are discontinuities in the entry of the slide code. Depicted is a slide code point 120 where the finger is first applied to the wire 100, and the finger slides to slide code point 121, where the finger is then lifted and placed on slide code point 122 and is then slid to slide code point 123. From there the finger remains in contact with wire 100 and changes direction to slide code point 124. The finger 103 is then lifted and placed at slide code point 125, and slid to its terminating location at slide code point 126. In some embodiments (e.g., in some embodiments where it may not be possible to uniquely determine which activation area is activated using only the current row and column signals of a matrix, as in the example of FIG. 3), it may be possible to ascertain position after sliding a certain minimum distance.

FIG. 15 shows a representation of the entry of a combination of tap codes and slide code. The finger 103 is placed at tap code point 130, then lifted, then placed at tap code point 131, then lifted and placed at tap code point 133. The finger 103 is then lifted and placed at slide code point 134 and slid to slide code point 135. The finger 103 is then lifted and placed at tap code point 136. Finger 103 is then lifted and placed at slide code point 137 and slid to slide code point 138 where it changes directions and slides to slide code point 139. Finally finger 103 is lifted and placed at tap code point 140.

In some embodiments, a tap code and/or slide code may encode one or more time periods associated with entry of the code. The time periods associated with entry of a tap code and/or slide code may include, but are not limited to, the time before an object (e.g., finger) is placed in contact with wire 100 (e.g., after the object is lifted, such as after entering a tap code or at a discontinuity in a slide code), the time for the object to slide from one slide code point to another, the time for the object to slide from one activation area to another, the time to enter one or more tap codes, and/or the time the object remains in contact with an activation area during a tap. In some embodiments, a tap code and/or slide code may use both time information and position information to encode data entry and/or security codes and/or control codes.

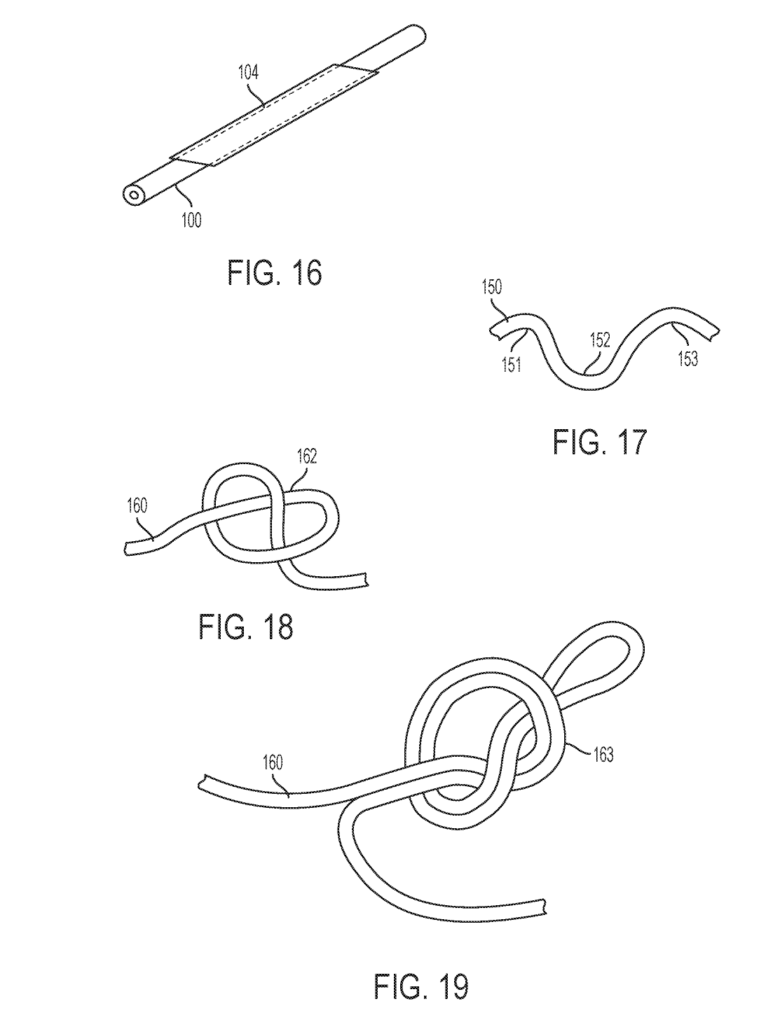

FIG. 16 shows a substrate 104 applied to a wire 100, according to some embodiments. In some embodiments, the substrate 104 may take the form of a tag or dongle or additional wire.

FIG. 17 shows a wire 150 upon which a piezo material (e.g., piezoelectric material or piezoresistive material) is disposed (e.g., printed, formed, deposited, and/or coated) to generate a voltage as the wire is being flexed, twisted, strained, compressed, and/or deformed, according to some embodiments. Shown is a first flex region 151, a second flex region 152, and a third flex region 153. In some embodiments, the piezo material may generate a voltage when mechanical force is applied to wire 150 (e.g., when the wire is being flexed, twisted, strained, compressed, and/or deformed). In some embodiments, the voltage generated by the piezo material when the wire is flexed, twisted, strained, compressed, and/or deformed may measurably differ from the voltage generated when the wire is not flexed, twisted, strained, compressed, and/or deformed (e.g., when the wire is subjected only to environmental mechanical forces such as gravity, atmospheric pressure, etc.)

FIG. 18 shows a wire 162 in an overhand knot corresponding to a code entry, according to some embodiments. In some embodiments, tying a given knot in a wire (e.g., a wire having a piezo material disposed thereon) may produce a corresponding voltage in the piezo material, which may match a voltage associated with a code.

FIG. 19 shows two wires in an overhand knot and in a bight configuration 163, where the overhand knot and the bight configuration collectively correspond to a code entry, according to some embodiments.

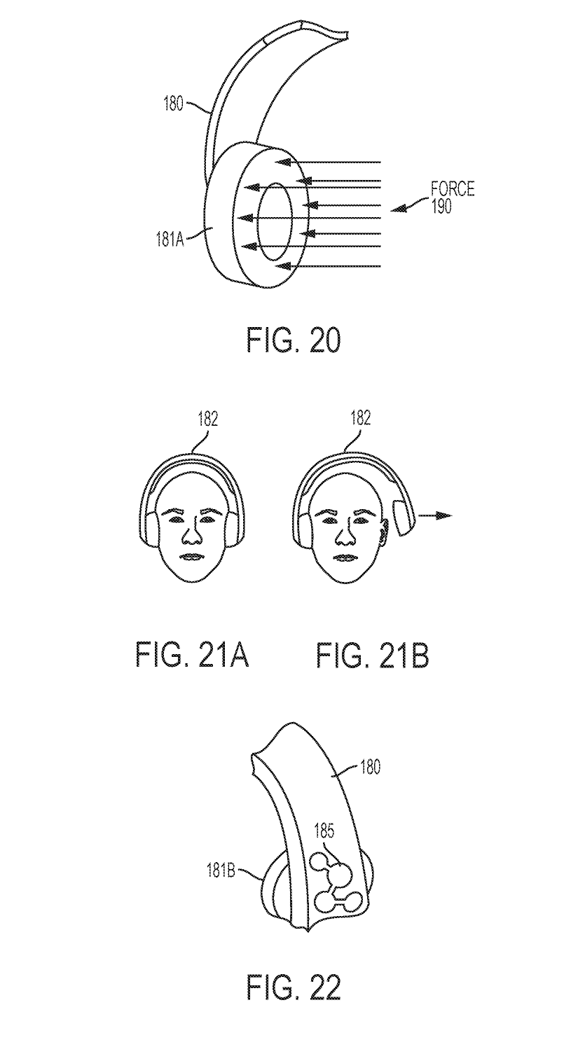

FIG. 20 shows a force 190 applied to the left cup 181A on flexible member 180 of a pair of headphones 182, according to some embodiments.

FIG. 21A show a person wearing a pair of headphones 182, according to some embodiments, and FIG. 21B shows a pair of headphones 182 being removed from one side of a person's head, according to some embodiments. In some embodiments, the removal of the headphones 182 may trigger any number of actions including but not limited to turning down audio volume, pausing music, restarting a song, and/or advancing to another song.

FIG. 22 shows a touch code 185 applied to flexible member 180 opposite right cup 181B on a pair of headphones 182, according to some embodiments.

In some embodiments, one or more components described herein (e.g., one or more components of a control system) may comprise and/or be at least partially formed from one or more conductive inks. Such components may include, but are not limited to, conductive lines (e.g., wires, traces, vias, column lines, row lines), sensors, sensor components (e.g., activation areas, electrodes, touch points, touch point electrodes), control units, controllers, power sources, and/or circuitry configured to produce a measurable change in a parameter as function of a change of a property of an activation area. In some embodiments, a conductive ink may comprise a conductive material that may be formed by the evaporation and/or curing of a binder/carrier liquid in which a conductive material is suspended. Examples of conductive inks may include, but are not limited to, metallic inks, such as aluminum ink. In some embodiments, the conductive ink used in a touch-sensitive control device may comprise a carbon-containing conductive ink. The use of carbon-containing conductive inks may be advantageous, in some but not necessarily all embodiments, as the resistance of structures formed using such inks may vary linearly with the length of the structure. This linear variability may make it easier to design resistive elements having specified resistances. While the use of carbon-containing conductive inks may be advantageous in some embodiments, it should be understood that the present disclosure is not limited to the use of carbon-containing conductive inks, and in some embodiments, conductive inks that are free of carbon may also be used.

In some embodiments, activation areas may be formed, printed, or otherwise fashioned using conductive inks or conventional materials and techniques. A method by which conductive inks may be printed or formed on surfaces has been taught in, for example, U.S. Pat. No. 8,198,979, issued Jun. 12, 2012, the disclosure of which is hereby incorporated by reference herein in its entirety. In some embodiments, the activation areas may be printed on a film, which may be used as a wire cover, integrated into a wire cover, or attached to a wire cover. Alternatively, the activation areas may be printed on a release paper, instead of a film, and molded to the outer surface of a wire cover (e.g., without being sealed in or covered by a film).

An ink layer may be applied to a film, release paper, or wire cover using a printing process as described above. Suitable inks for forming ink layers include without limitation Noriphan® HTR, a solvent-based, one-component screen printing ink based on a high temperature resistant thermoplastic resin which is supplied by Pröll KG of Germany, and Nazdar® 9600 Series inks with 3% catalyst, which are supplied by the Nazdar Company of Shawnee, Kans.

In some embodiments, a sensor and/or sensor component (e.g., one or more activation areas) may be formed by spraying or ink jetting. In such an embodiment, a conductive ink may be installed into an ink jet or three-dimensional printer and then sprayed onto the surface of a wire cover (e.g., directly onto the wire cover). In some embodiments, the preparation of a sensor may be indirect. For instance, the sensor may be in-molded, insert-molded, printed, or otherwise formed onto a separate film that may subsequently be attached to the wire or the wire cover. In some embodiments, the separate film may be a sleeve that fits around the circumference of a wire or wire cover. A wide variety of printing processes may be used to deposit various ink layers, including without limitation screen printing, off-set printing, gravure printing, flexographic printing, pad printing, intaglio printing, letter press printing, ink jet printing, and bubble jet printing.

In some embodiments, a touch sensitive control device may comprise a linear control device. In some embodiments, a linear control device may use linear feedback to produce a control signal based on one or more variables.

It should be understood that various combinations of the structures, components, materials and/or elements, in addition to those specifically shown in the drawings and/or described in the present disclosure, are contemplated and are within the scope of the present disclosure. Reference throughout the specification to “one embodiment” or “an embodiment” or “some embodiments” means that a particular feature, structure, material, or characteristic described in connection with the embodiment(s) is included in at least one embodiment of the present invention, but not necessarily in all embodiments. Consequently, appearances of the phrases “in one embodiment,” “in an embodiment,” or “in some embodiments” in various places throughout the disclosure are not necessarily referring to the same embodiment. Furthermore, the particular features, structures, materials, or characteristics (including, but not limited to, sensor locations, sensor types, and/or sensor materials) can be combined in any suitable manner in one or more embodiments.

Unless the context clearly requires otherwise, throughout the disclosure, the words “comprise,” “comprising,” and the like are to be construed in an inclusive sense as opposed to an exclusive or exhaustive sense; that is to say, in a sense of “including, but not limited to.” Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list; all of the items in the list; and any combination of the items in the list.

Having thus described several aspects of at least one embodiment of the technology, it is to be appreciated that various alterations, modifications, and improvements will readily occur to those skilled in the art. Such alterations, modifications, and improvements are intended to be within the spirit and scope of the technology. Accordingly, the foregoing description and drawings provide non-limiting examples only.

### COMPONENTS

1 electrode E1
2 electrode E2
3 electrode E3
4 electrode E4
5 electrode E5
6 electrode E6
7 electrode E7
8 electrode E8
9 electrode E9
10 electrode E10
11 common trace
12 two pair conductor cable
13 touch point electrode (TPE1)
14 touch point electrode (TPE2)
15 touch point electrode (TPE3)
16 touch point electrode (TPE4)
17 touch point electrode (TPE5)
21 column line (MC1)
22 column line (MC2)
23 column line (MC3)
24 column line (MC4)
25 row line (MR5)
26 row line (MR6)
27 row line (MR7)
28 row line (MR8)
32 activation area (ME1)
33 activation area (ME2)
34 activation area (ME3)
35 activation area (ME4)
36 activation area (ME5)
37 activation area (ME6)
38 activation area (ME7)
39 activation area (ME8)
40 activation area (ME9)
41 activation area (ME10)
42 activation area (ME11)
43 activation area (ME12)
44 activation area (ME13)
45 activation area (ME14)
46 activation area (ME15)
47 activation area (ME16)
48 activation area (ME17)
49 activation area (ME18)
50 activation area (ME19)
51 activation area (ME20)
52 activation area (ME21)
53 activation area (ME22)
54 activation area (ME23)
55 activation area (ME24)
56 activation area (ME25)
57 activation area (ME26)
58 activation area (ME27)
59 activation area (ME28)
60 activation area (ME29)
61 activation area (ME30)
62 activation area (ME31)
63 activation area (ME32)
64 upper matrix
65 lower matrix
68 left resistive electrode
69 right resistive electrode
70 left triangular electrode
71 right triangular electrode
72 left electrode
73 right electrode
74 left triangular electrode with triangular spacing
75 right triangular electrode with triangular spacing
76 top plate
77 bottom plate
78 left electrode
79 right electrode
80 left resistive electrode
81 right resistive electrode
82 upper terminal
83 lower terminal
84 upper close resistive portion
85 upper far resistive portion
86 lower close resistive portion
87 lower far resistive portion
88 capacitive bridge
90 upper terminal
91 lower terminal
93 near resistive portion
94 far resistive portion
95 conductive element
96 capacitive bridge
100 wire
101 beginning of sensing region
102 end of sensing region
103 finger
104 substrate
110 slide code point
111 slide code point
112 slide code point
113 slide code point
114 slide code point
115 slide code point
120 slide code point
121 slide code point
122 slide code point
123 slide code point
124 slide code point
125 slide code point
126 slide code point
130 tap code point
131 tap code point
133 tap code point
134 slide code point
135 slide code point
136 tap code point
137 slide code point
138 slide code point
139 slide code point
140 tap code point
150 wire
151 first flex region
152 second flex region
153 third flex region
160 wire
162 a wire in an overhand knot
163 two wires in an overhand knot and in a bight configuration 180 flexible member
181A left cup
181B right cup
182 pair of headphones
185 touch code
190 force

1. An earphone apparatus, comprising:
one or more speakers configured to convert audio signals to sound;
one or more sensors; and
a control unit coupled to the one or more sensors and configured to control an operation of a device based, at least in part, on second signals provided by the one or more sensors.

2. The earphone apparatus of claim 1, wherein the control unit is configured to determine whether at least a portion of the earphone apparatus is disposed proximate to a head of a user based, at least in part, on the second signals provided by the one or more sensors.

3. The earphone apparatus of claim 2, wherein, in response to determining that at least a portion of the earphone apparatus is not disposed proximate to a head of a user, the control unit is configured to perform at least one sound-control operation comprising controlling the one or more speakers to change a volume of the sound produced by the one or more speakers, and/or controlling the earphone apparatus to stop transmission of audio signals to the one or more speakers.

4. The earphone apparatus of claim 2, wherein, in response to determining that at least a portion of the earphone apparatus is disposed proximate to a head of a user, the control unit is configured to perform at least one sound-control operation comprising controlling the one or more speakers to change a volume of the sound produced by the one or more speakers, and/or controlling the earphone apparatus to begin or continue transmission of audio signals to the one or more speakers.

5. The earphone apparatus of claim 2, wherein the one or more speakers include a first speaker, wherein the earphone apparatus further comprises one or more speaker housings including a first speaker housing configured to house the first speaker and configured to encompass an ear, press against an ear, and/or penetrate an ear canal, and wherein the one or more sensors include a first sensor disposed on and/or in the first speaker housing.

6. The earphone apparatus of claim 5, wherein determining whether at least a portion of the earphone apparatus is disposed proximate to a head of a user comprises determining whether the first speaker housing is disposed proximate to an ear, pressed against an ear, and/or disposed in an ear canal.

7. The earphone apparatus of claim 5, wherein the first sensor comprises a material, wherein a property of the material depends, at least in part, on a force applied to the material, and wherein the force applied to the material depends, at least in part, on whether the first speaker housing is disposed proximate to an ear, pressed against an ear, and/or disposed in an ear canal.

8. The earphone apparatus of claim 7, wherein the material comprises conductive foam.

9. The earphone apparatus of claim 8, wherein a resistance of the conductive foam is configured to change in response to compression of the conductive foam.

10. The earphone apparatus of claim 8, wherein the conductive foam comprises polyurethane foam, carbon-impregnated foam, anti-static foam, electro-static discharge foam, and/or resistive foam.

11. The earphone apparatus of claim 7, wherein the material comprises a piezoelectric material, and wherein an electrical potential of the piezoelectric material is configured to change in response to application of mechanical force to the speaker housing.

12. The earphone apparatus of claim 7, wherein the material comprises a piezoresistive material, and wherein a resistance of the piezoresistive material is configured to change in response to application of mechanical force to the speaker housing.

13. The earphone apparatus of claim 7, wherein the material comprises conductive ink, and wherein a capacitance of the conductive ink is configured to change in response to application of electrostatic force to the conductive ink by a body part proximate to first speaker housing and/or in contact with the first speaker housing.

14. The earphone apparatus of claim 5, wherein:
the one or more speakers further include a second speaker,
the one or more speaker housings further include a second speaker housing configured to house the second speaker and configured to encompass an ear, press against an ear, and/or penetrate an ear canal,
the one or more sensors further include a second sensor disposed on and/or in the second speaker housing, and
the second sensor comprises a material, wherein a property of the material of the second sensor depends, at least in part, on a force applied to the material of the second sensor, and wherein the force applied to the material of the second sensor depends, at least in part, on whether the second speaker housing is disposed proximate to an ear, pressed against an ear, and/or disposed in an ear canal.

15. The earphone apparatus of claim 2, wherein the one or more speakers include first and second speakers, and wherein the earphone apparatus further comprises:
first and second speaker housings configured to house the first and second speakers, respectively, wherein each of the first and second speaker housings is configured to encompass an ear, press against an ear, and/or penetrate an ear canal; and
a member coupling the first speaker housing to the second speaker housing and configured to partially cover a head of a user, wherein the member includes a first of the one or more sensors.

16. The earphone apparatus of claim 15, wherein determining whether at least a portion of the earphone apparatus is disposed proximate to a head of a user comprises determining whether the member is deformed.

17. The earphone apparatus of claim 15, wherein the first sensor comprises a material, wherein a property of the material depends, at least in part, on a deformation of the material, and wherein the deformation of the material depends, at least in part, on application of a mechanical force to the member by a head of a user and/or by the first and second speaker housings.

18. The earphone apparatus of claim 17, wherein the material comprises a piezoelectric material, and wherein an electrical potential of the piezoelectric material is configured to change in response to application of mechanical force to the member.

19-83. (canceled)

84. An apparatus comprising:
one or more wires at least partially enclosed in a wire cover;
a sensor disposed on the wire cover, wherein a property of the sensor is configured to change in response to application of force to the sensor; and
a control unit coupled to the sensor and configured to control an operation of a device based, at least in part, on the change in the property of the sensor.

85-121. (canceled)

122. A touch sensitive control device comprising:
a substrate;
at least one activation area;
a protective layer and/or coating;
at least one conductive trace electrically connected to said at least one activation area;
circuitry capable of producing measurable change of at least one parameter as a function of capacitance change of said at least one activation area;
a communication unit configured to communicate said measurable change to another device;
a source of power; and
a controller.

123-204. (canceled)
